(19) United States
(12) Patent Application Publication
(10) Pub. No.: US 2003/0198341 A1
(43) Pub. Date: Oct. 23, 2003

(54) Integrated POTS/MLT card

(75) Inventors: Christopher S. Smith, Mission Viejo, CA (US); Richard Thomas Mann, Costa Mesa, CA (US)

Correspondence Address: Fogg Slifer Polglaze, Leffert & Jay, P.A., P.O. Box 581009, Minneapolis, MN, 55458-1009, US

(73) Assignee: ADC DSL Systems, Inc.

(21) Appl. No.: 10/127,921

(22) Filed: Apr. 23, 2002

(51) Int. Cl. H04M 1/00; H04M 9/00

(52) U.S. Cl. 379/413.03; 379/399.01

(57) ABSTRACT

An integrated plain old telephone service (POTS) and metallic loop testing (MLT) card provides lifeline telephone service with multiple channel data service. The integrated card can be piggybacked with an ADSL card to provide a single package of POTS, MLT, and ADSL services.

### FIELD

The present invention relates generally to telecommunications, and more specifically to integrated lifeline and data services in telecommunications cards.

### BACKGROUND

There are a variety of telecommunications services that a typical customer wishes to have in today's society. For example, telephone voice service is nearly universally desired and available in modern communities. Telephone voice service is typically transmitted via a twisted wire pair to customer premises. Such wire service is line powered, and is typically referred to as plain old telephone service (POTS). POTS is often referred to as a lifeline service, that is, if power in the neighborhood goes down, but the wire connection to the central office at which the POTS originates remains, telephones are available for use. They do not require additional power for service.

Other services have become more and more common, as well as desirable, for subscribers. Such services include by way of example digital subscriber line (DSL), which is a high bandwidth service capable of data transfer, as well as voice telephone service similar in type to POTS, but as part of a high bandwidth solution, often referred to as derived POTS. DSL is available in a variety of types such as high rate DSL (HDSL), asymmetric DSL (ADSL), very high rate DSL (VDSL) and the like. When DSL services are interrupted such as by a power outage or the like, however, the derived POTS type availability within those services also becomes unavailable.

In order to provide multiple services to telecommunications customers, multiple cards or multiple shelves are used at a main chassis or central office to coordinate and distribute the various services, such as DSL services, POTS services, metallic loop testing (MLT) services, and the like. This requires the usage of multiple shelves of space in the chassis or central office for the various services and their associated cards.

With available space at a premium due to ever expanding demand for data services to ever more areas, the proliferation of many cards is creating space shortages. Further, multiple cards, or chassis, each for a different purpose, require ever more space for each such service added.

Therefore, there is a need in the art for a reduction in the space used for POTS and MLT solutions, and for an integrated POTS/MLT solution.

### SUMMARY

Other embodiments are described and claimed.

### BRIEF DESCRIPTION OF DRAWINGS

FIG. 1 is a block diagram of a POTS/MLT card according to one embodiment of the present invention;

FIG. 2 is a more detailed block diagram of the POTS/MLT card of FIG. 1, but showing a POTS filter embodiment rather than the POTS splitter embodiment of FIG. 1;

FIG. 2A is a block diagram of cell bus and voice interfaces according to one embodiment of the present invention;

FIG. 3 is an end elevation view of a POTS/MLT card and an ADSL card according to another embodiment of the present invention;

FIG. 4 is a block diagram of a management processor block according to another embodiment of the present invention;

FIG. 5 is a block diagram of a voice processor block according to another embodiment of the present invention;

FIG. 6 is a block diagram of a DSP processor block according to another embodiment of the present invention;

FIG. 7 is a block diagram of one embodiment of POTS and MLT interfaces according to another embodiment of the present invention;

FIG. 8 is a block diagram showing process flow in another embodiment of the present invention;

FIG. 8A is a block diagram showing process flow in another embodiment of the present invention;

FIG. 9 is a block diagram of a POTS block according to another embodiment of the present invention;

FIG. 10 is a block diagram of an MLT block according to another embodiment of the present invention; and

FIG. 11 is a block diagram of a computer on which embodiments of the present invention are practiced.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The embodiments of the present invention, described in greater detail below, provide POTS and MLT service on a combined POTS/MLT card. Other embodiments piggyback an ADSL card to the POTS/MLT card for full POTS and ADSL functionality in a smaller package. All of the combination and piggyback cards are capable in various embodiments of management by one management entity such as a management card.

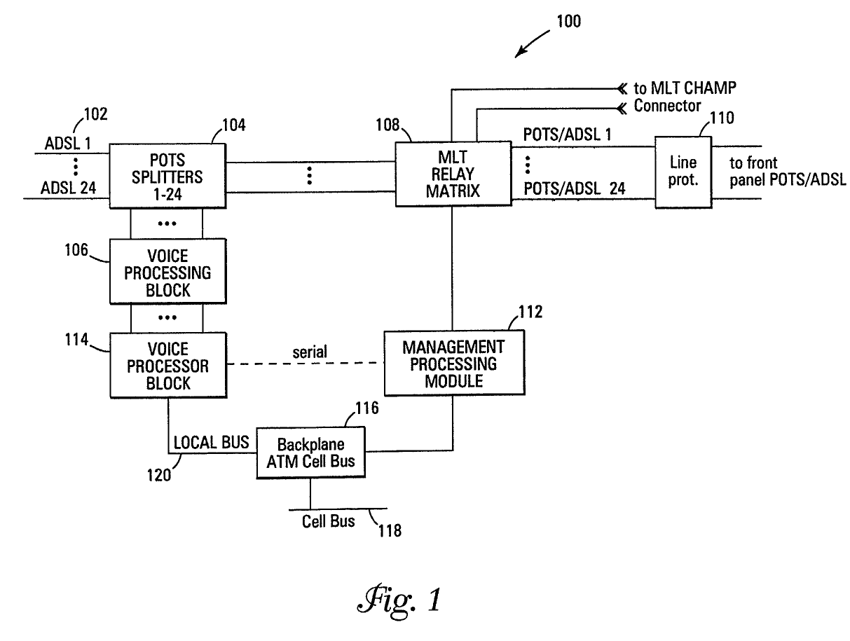

FIG. 1 is a block diagram of a POTS/MLT card 100 according to one embodiment of the present invention. POTS/MLT card 100 comprises ADSL inputs 102 (in one embodiment 24 such inputs are used) from a backplane POTS connector feeding into POTS splitters 104. Also fed into POTS splitters 104 are voice signals from voice processing block 106. The output from POTS splitters 104, 24 channels in this embodiment, is fed to MLT relay matrix 108, which allows selection of any of the lines for MLT testing at the direction of an external MLT tester. The combined POTS/ADSL signals output from the MLT relay matrix 108 are subjected to line protection 110, and presented to the subscriber via a champ connector on the front panel of the card 100. The card 100 is controlled by management processing module 112. Management processing module 112 is connected via a serial port to ARM processor block 114 which controls the voice processing block 106. Each of the management processing block 112 and the ARM block 114 are connected to backplane asynchronous transfer mode (ATM) cell bus 116. The cell bus 116 receives over the backplane compressed ATM adaptation layer 2 protocols (AAL2) voice over ATM (VOATM) signals, and presents them via local bus 120 to the voice processing block 106 controlled by the ARM processor block 114 to generate POTS channels.

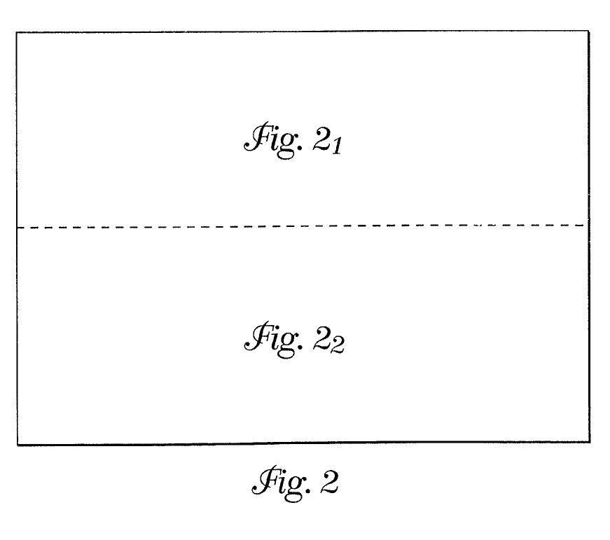

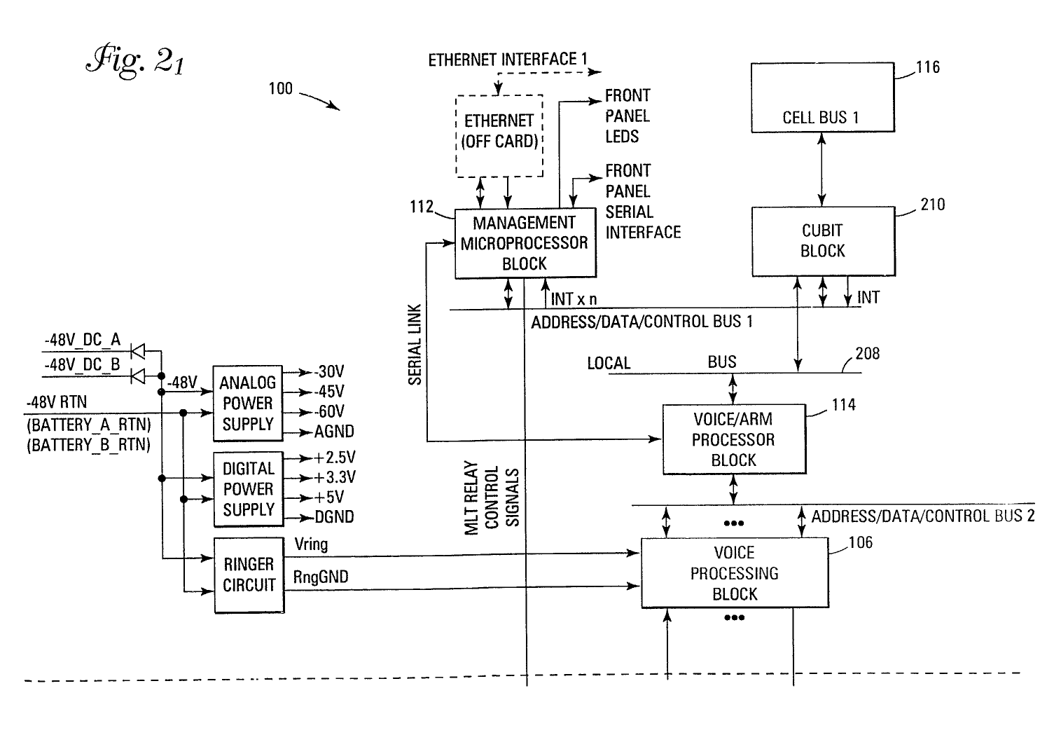

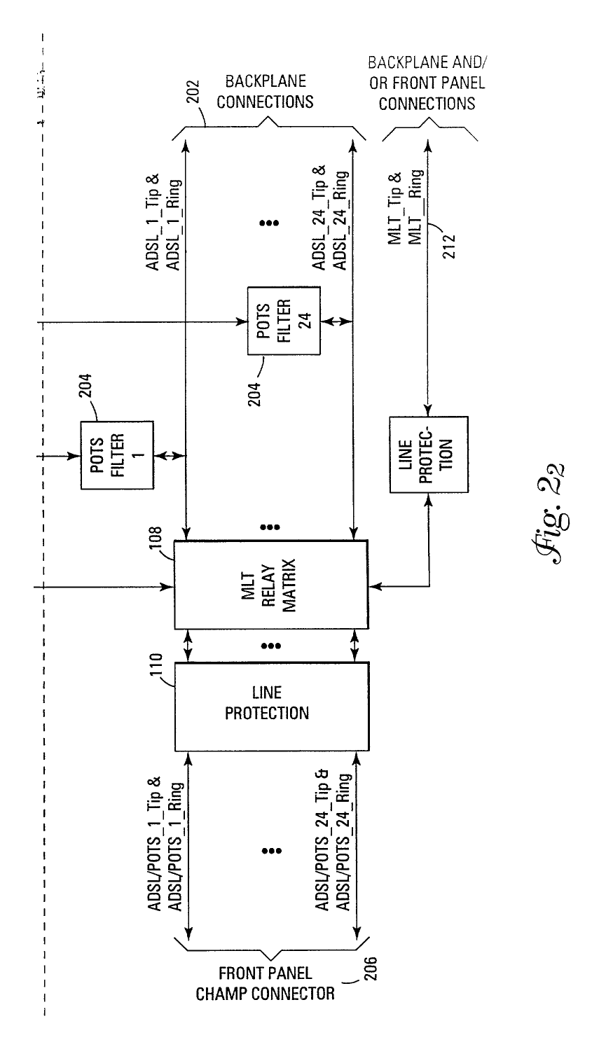

FIG. 2 is a more detailed block diagram of the embodiment of FIG. 1, but showing a POTS filter embodiment rather than the POTS splitter embodiment of FIG. 1. The integrated POTS/MLT card 100 provides metallic loop test (MLT), voice over ATM, voice compression, and ADSL POTS filter functions. The card 100 is a plug in option to access servers and remote access concentrators, for example. In one embodiment, the POTS/MLT card 100 is installed into a channel card slot where it connects via the backplane 202 to 24 ADSL channels from an ADSL channel card. The POTS/MLT card 100 is connected to a corresponding external ADSL channel card by jumpering backplane champ connectors between the card 100 and the ADSL channel card.

The 24 POTS channels from voice processing block 106 are added via analog POTS filters 204 to the 24 ADSL channels from the backplane, pass through MLT relay matrix 108 and secondary line protection 110, and exit the front panel of the card 100 via a 25-pair champ connector 206. The POTS channels are generated via subscriber line interface circuits (SLICs), coder/decoders (CODECs), and digital signal processing (DSP) compressors receiving compressed AAL2 voice over ATM (VOATM) via the local bus 208 from a cubit 210 and backplane cell bus interface 116.

The cubit 210 and cell bus 116 are controlled via management processing module 112 (or MIPS processor block). Management functions are sent by an external management card to the card 100 via the cell bus 116. The management processing block 112 also controls front panel light emitting diodes (LEDs, described further below), the MLT interface, and a debug interface. The voice processing block 106 is controlled via ARM processor 114 (or voice processor).

Data is transferred between the cell buses and the ARM processor block of the POTS circuit as detailed in FIG. 2A. The cubit 210 takes data to and from the cell bus and passes the data to and from the voice processor block via the local bus 208.

An external MLT test set is connected to the chassis for the purposes of performing MLT testing. The MLT test set connects in one embodiment to the chassis via a serial two-wire RS-232 interface and a four-wire metallic test bus.

The chassis backplane routes the RS-232 interface to the external management card inserted into the chassis. To test a specific line, the external management card decodes MLT commands from the MLT test set and routes the commands over the cell bus 116 to the appropriate POTS/MLT card under test, such as card 100. The management processing block 112 on the card such as card 100 under test then places the MLT relays on the card into the appropriate positions to perform the MLT.

The metallic test bus consists of a test-in tip and ring pair and a test-out tip and ring pair. These test pairs are routed by the chassis backplane to each channel card slot within the chassis. The individual cards such as card 100 connect to these test pairs via the backplane at 212 and route the test pairs to their MLT relays. Alternately, the MLT-in test relays may be routed to and controlled by a front panel MLT interface.

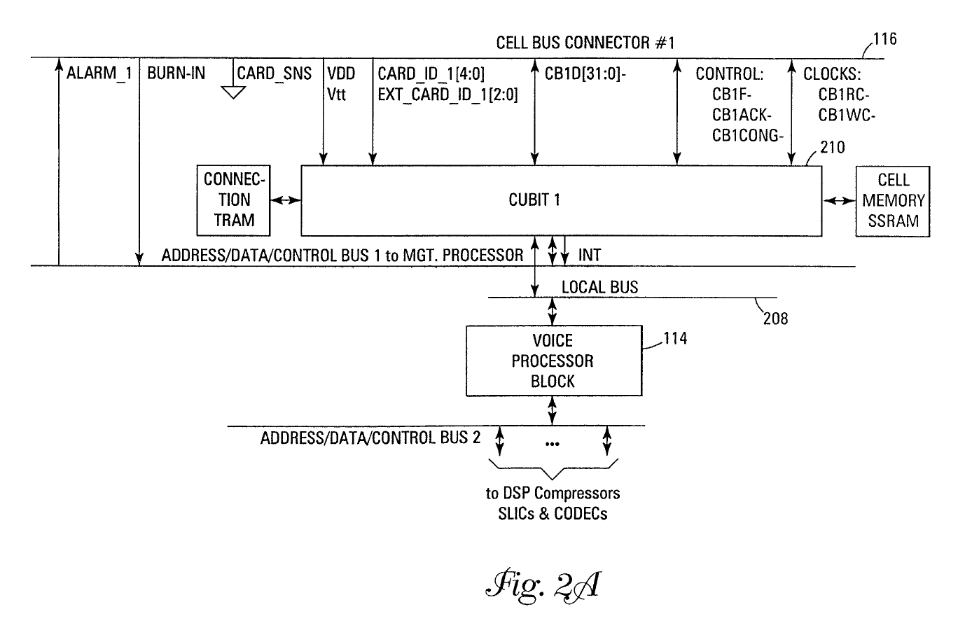

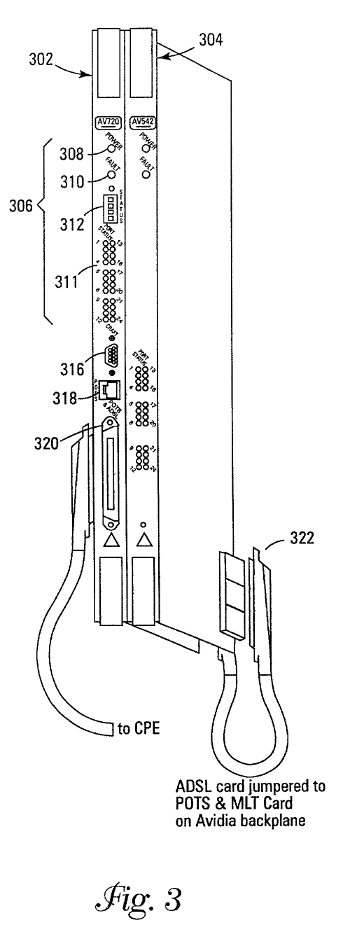

A front panel elevation view of a representative embodiment card 302 piggybacked to an ADSL card 304 is shown in FIG. 3. The card 302 in one embodiment is a POTS/MLT card such as card 100 described above. The details of the mechanics of the connectors and the like of the card 302 are described in greater detail in United States Patent Application entitled ELECTRONIC CIRCUIT CARDS, owned by the assignee of the present invention, and are incorporated in their entirety herein by reference. Card 302 has LED banks 306 comprising a power LED 308, a fault LED 310, a paired ADSL card slot LED bank 312, and port status LEDs 314. Craft port 316, POTS connector 318, and parallel connector 320 are used for various connections to the chassis, data lines, voice lines, and the like as noted. ADSL card 304 is piggybacked to POTS/MLT card 302 and connected at 322 via jumpered backplane champ connectors as described above.

The POTS/MLT card provides the front panel craft serial interface 316 via a DB-9 connector. The front panel craft serial interface 316 is utilized in some embodiments as an MLT serial interface, debug interface, and software download interface, but may be used for other purposes as well.

The LED banks 306 including power LED 308, fault LED 310, paired ADSL card slot LED bank 312, and port status LEDs 314 are described in further detail with respect to Table 1.

The power LED 308 illuminates as soon as the power is available. During self-test, the fault LED 310 operates according to the self-test procedures described below with respect to testability self-testing. During self-test, the port status LEDs 314 also operate according to the self test procedures described below with respect to testability self-testing. The port status LEDs are extinguished for two seconds upon completion of the self-test, and then operate normally according to Table 1.

The fault LED 310 also illuminates whenever central office battery power is present on the POTS/MLT card and at least one of the following conditions exist:

the fuse on the POTS/MLT card opens; one or more POTS/MLT card power supplies are faulty;

the POTS/MLT card is in reset; or

the microcontroller cannot control the POTS/MLT card.

TABLE 1

| LED | Mode | Color | Function |
|---|---|---|---|
| POWER | On | Green | Indicates that the POTS/MLT card is receiving power and that the power |
| | | | supplies are functioning properly. |
| | Off | None | Indicates one of the following faults: |
| | | | 1) The POTSIMLT card is not receiving power; or |
| | | | 2) The power supply is not functioning properly. |
| FAULT | On | Red | Indicates that a function on the POTSIMLT card is completely inoperable. |
| | Off | None | Indicates that the POTSIMLT card may be operable. |
| Paired | 4-char x | Green | Numerically indicates the slot number of the companion ADSL card. |
| ADSL Card | 5 × 5 pixels | | |
| Slot | | | |
| PORT | On | Green | Indicates that the baseband POTS service of the corresponding subscriber loop |
| STATUS | | | is in the off-hook condition. |
| (1-24) | Flashing | Green | Indicates that the baseband POTS service of the corresponding subscriber loop |
| | 10 Hz rate | | is in ringing condition. |
| | Off | None | Indicates that the baseband POTS service of the corresponding subscriber loop |
| | | | is in the on-hook or non-ringing condition. |
| | On | Yellow | Indicates that the corresponding subscriber port is placed in MLT bridging |
| | | | mode |
| | Flashing | Yellow | Indicates that the corresponding subscriber port is placed in MLT in/out test |
| | 1 Hz rate | | mode: connecting the subscriber loop to the MLT test path. |

Whenever the POTS/MLT card receives an LED test command from the external management card, the POTS/MLT card performs an LED test. All LEDs on the POTS/MLT card remain illuminated until the external management card cancels the LED test. Bicolor LEDs alternate in color every two seconds during the test. Once the external management card cancels the LED test, all LEDs and LED segments on the POTS/MLT card turn off for a period of time, in one embodiment two seconds, before resuming their normal modes of operation.

Management Processor Block

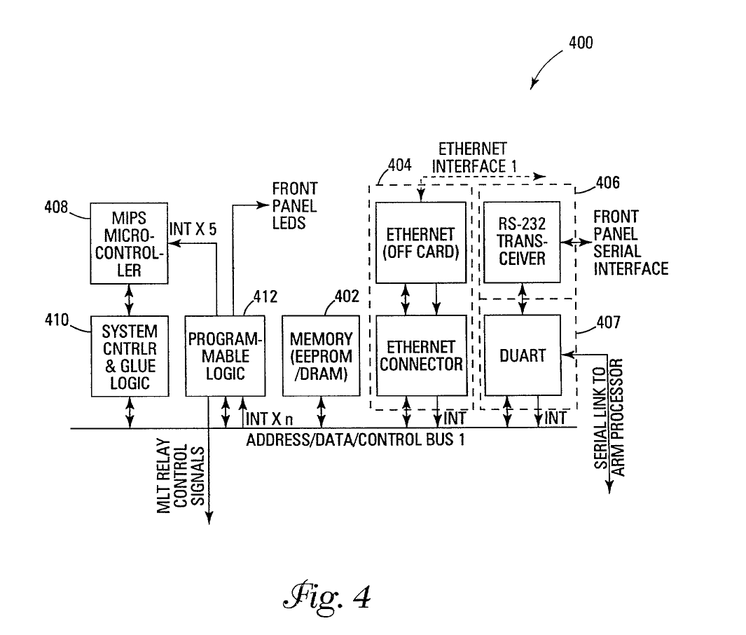

Embodiments of the POTS/MLT card, such as card 100, have a management processor to set card configuration, provide card status, and to control the MLT relays. One embodiment of a management processor block 400 is shown in greater detail in FIG. 4. The management processor block 400 comprises various read only memories (ROMs) and random access memories (RAMs) 402, an Ethernet test port 404, a front panel serial port 406, and a serial data link 407 to an ARM or voice processor block such as block 114. The block 400 also contains a microcontroller 408 connected to a system controller 410 and programmable logic 412. The microcontroller in combination with the programmable logic generates MLT control signals for the MLT relay matrix when a command is received along the backplane for an MLT test. Further, the microcontroller communicates with the RISC processor via the serial interface 407 for management of voice channel and data generation and decoding.

In one embodiment, the processor block 400 executes from system or block dynamic RAM. Part of memory 402 in one embodiment is electronically erasable programmable ROM (EEPROM) which stores system configuration information for the card such as card 100 on which the block 400 is located and also for each local and remote transceiver associated with the card.

The processor block also in one embodiment stores POTS configuration for the system or card on which it is located in non-volatile RAM (NVRAM). POTS status is collected by the processor block 400 from the voice processor, and is sent in one embodiment to the external management card in the chassis in which card 100 on which the processor block 400 resides is located. At power-up, the processor block reads a POTS configuration from NVRAM and passes the POTS configuration data to the voice processor block to configure each POTS channel.

ARM/Voice Processor Block

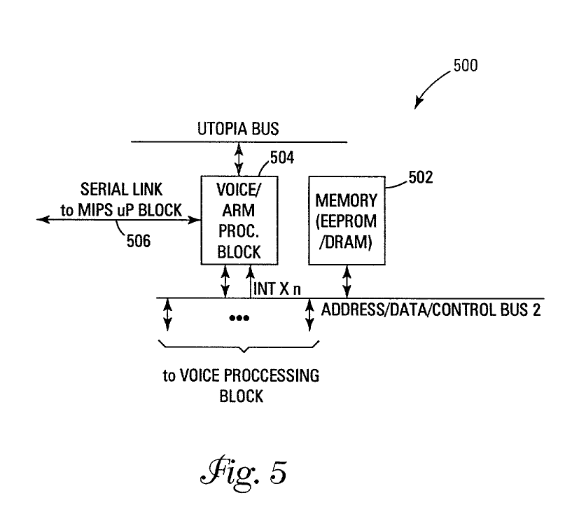

Embodiments of the POTS/MLT card, such as card 100, have an ARM or voice processor block to control a voice processing block and to provide a data path between the voice processor block and a cubit block via an internal bus such as bus 208 shown in FIG. 2. One embodiment of a voice processor block 500 is shown in greater detail in FIG. 5.

In one embodiment, the voice processor block 500 comprises various read only memories (ROMs) and random access memories (RAMs) 502, a RISC processor 504, and a serial data link 506 to the management processor block.

The voice processor block in one embodiment executes from system or block dynamic RAM. At power-up, the management processor, discussed above, reads POTS configuration from NVRAM and passes the POTS configuration data to the voice processor to configure each POTS channel.

DSP Processor

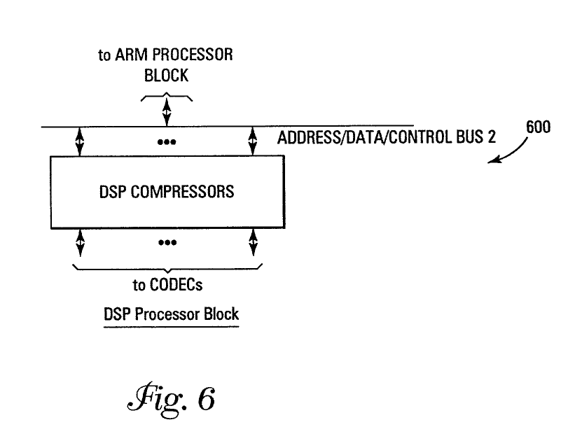

Embodiments of the POTS/MLT card, such as card 100, have a DSP processor interfacing with the voice processor and CODEC blocks within a voice processing block such as block 106 of FIG. 1 or 2 and operating within, controlling, and managing the voice processing block. The DSP processor provides compression and decompression of digital voice data between the voice processor and CODECs. One embodiment of a DSP processor block 600 is shown in greater detail in FIG. 6. In this embodiment, the DSP processor block is a component of a voice processing block such as block 106 shown in FIG. 2.

POTS and MLT INTERFACES

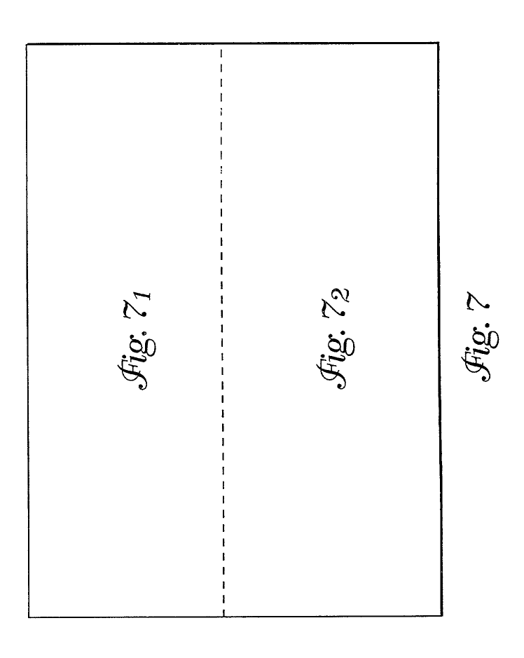

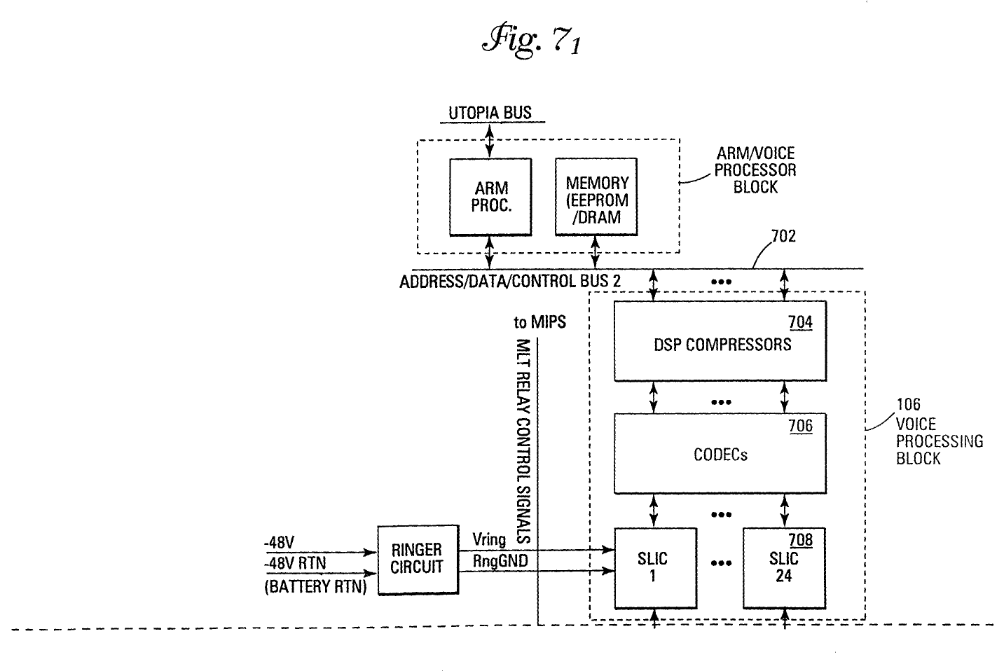

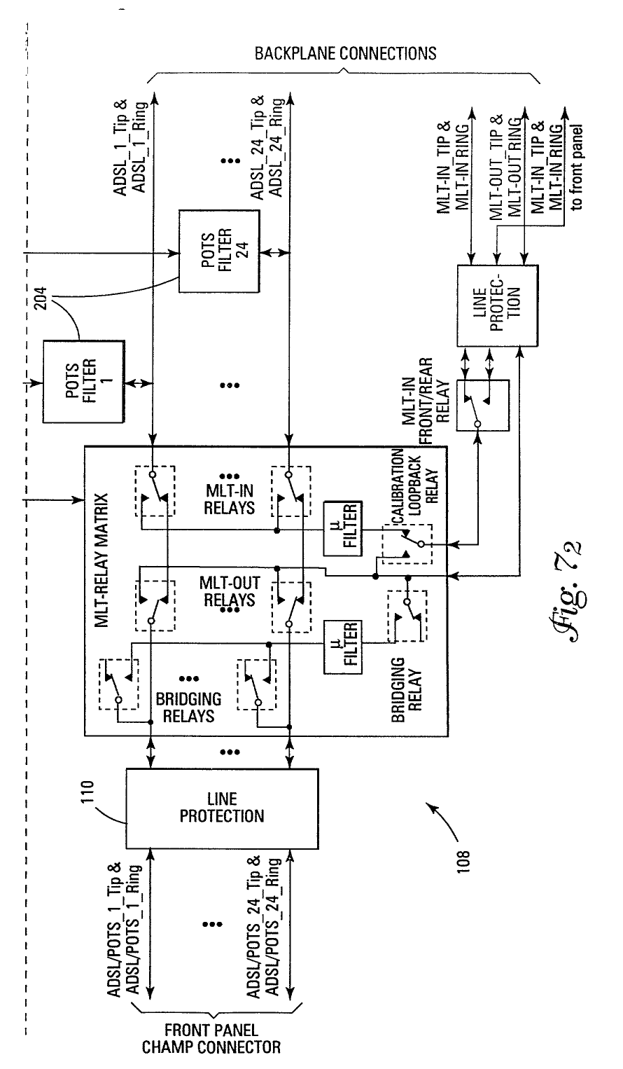

The POTS and MLT interfaces for a card such as card 100 are shown in greater detail in FIG. 7. The transfer of voice data from the cell bus (not shown) to the voice processing block 106 via the local bus presents voice data to voice processing block 106 over address data control bus 702 as shown. The voice data to the voice processing block is split into 24 voice channels in the voice processing block by compressing with DSP compressors 704, decoding in CODECs 706, and to individual subscriber line interface circuits (SLICs) 708 to generate the 24 POTS channels.

The ADSL/POTS tip and ring circuits are in one embodiment connected to a 25-pair champ connector on the front panel of a POTS/MLT card such as card 100. The MLT tip and ring circuits interface to the backplane via the MLT pins as described above. The MLT interface also includes serial transmit and receive command interface signals between the external management card inserted into the shelf or chassis, and the MLT test set. The external management card decodes the MLT commands from the MLT test set and routes the commands over the cell bus to the appropriate card such as card 100 under test. The management processor (not shown) then places the MLT relays on the card into the appropriate positions to perform the MLT. The relay matrix is described in greater detail in United States Patent Application entitled CIRCUITS AND METHODS FOR TESTING POTS SERVICE, owned by the assignee of the present application, filed on Feb. 5, 2002, and which is incorporated herein in its entirety by reference.

In another embodiment, the MLT circuitry interfaces to the POTS/MLT card via a front panel interface. The front panel interface in one embodiment comprises an RJ-11 connector for the connection of the MLT-in tip and ring signals and a DB-9 craft interface to receive the serial MLT commands from the MLT tester. In addition to routing the MLT-in interface to the backplane, the MLT-in interface also routes to a front panel RJ-11 connector. A relay selects whether the MLT-in pair is routed to the backplane connector or to the front panel connector.

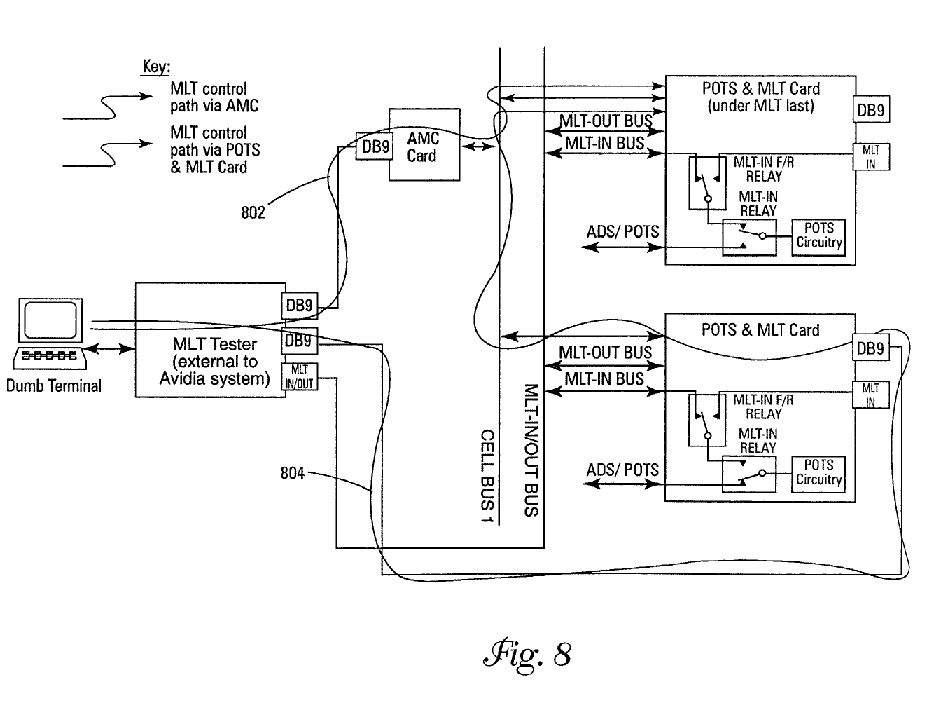

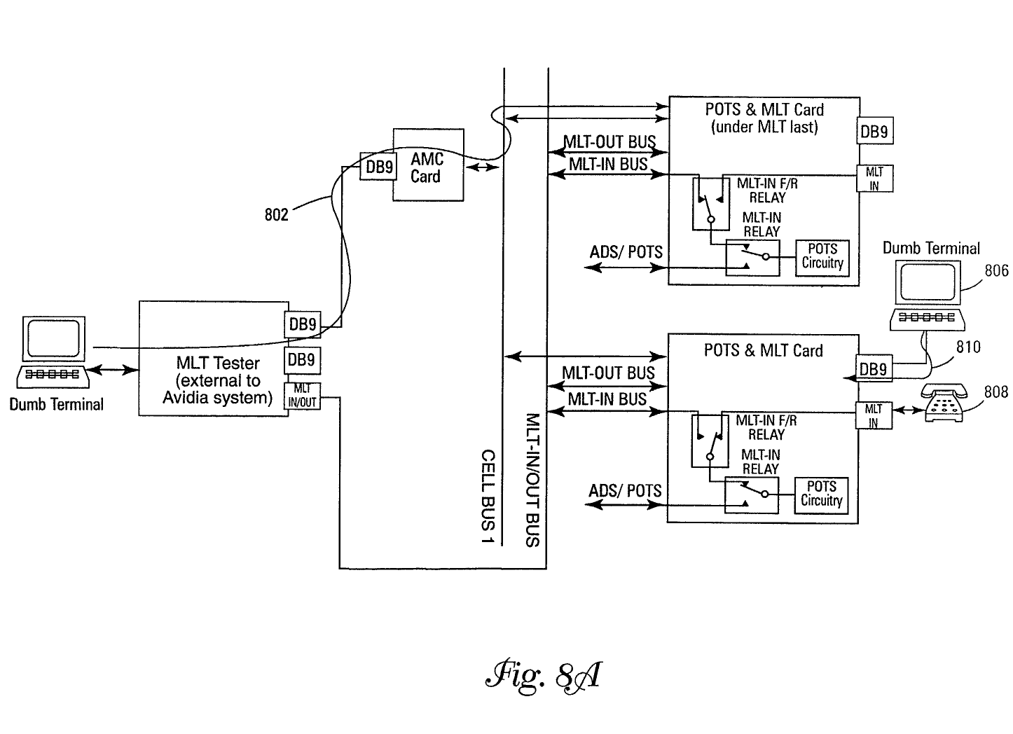

The front panel MLT interface of the card serves two applications. The first application is that the front panel serial MLT interface through the DB-9 connector serves as a redundant test control path from an MLT tester. The normal serial MLT control interface is through the external management card's serial port. However, the POTS/MLT card's DB-9 serial control interface is used as a backup in the case of external management card failure. The redundant serial control interface application through the DB-9 connector is as shown with arrows 802 and 804 in FIG. 8, which show respectively the MLT control path via the external management card, and the MLT control path via the POTS/MLT card.

The second application is that the front panel serial DB-9 interface combined with the front panel MLT-In RJ-11 interface may be used to perform “listen in” testing on any card's SLICs. As shown in FIG. 8A, this application connects a dumb terminal 806 and phone 808 to the POTS/MLT card via the front panel MLT interface. The phone 808 tests the line by listening for dial tone or by placing an outgoing phone call as shown by arrow 810.

Note that it is possible for both the applications of FIG. 8 and FIG. 8A to occur simultaneously. Software also then resolves all cases of possible command conflicts. Command conflicts can include MLT commands simultaneously originating via the external management card from the MLT tester, via a POTS/MLT card's front panel interface from the MLT tester, or via a POTS/MLT card's front panel interface from a dumb terminal.

POTS Requirements

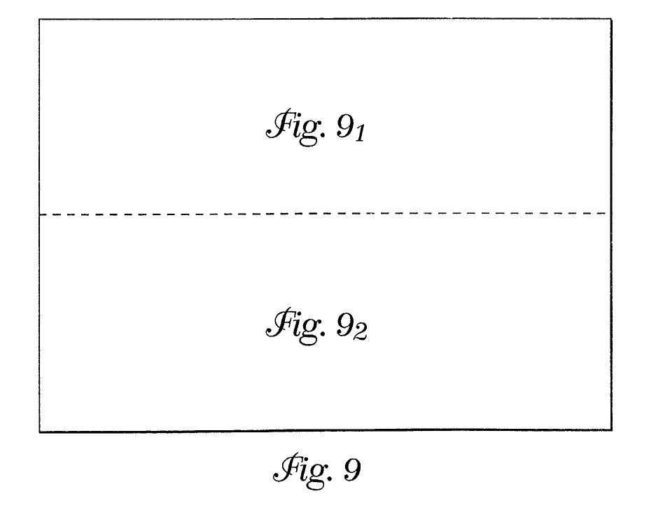

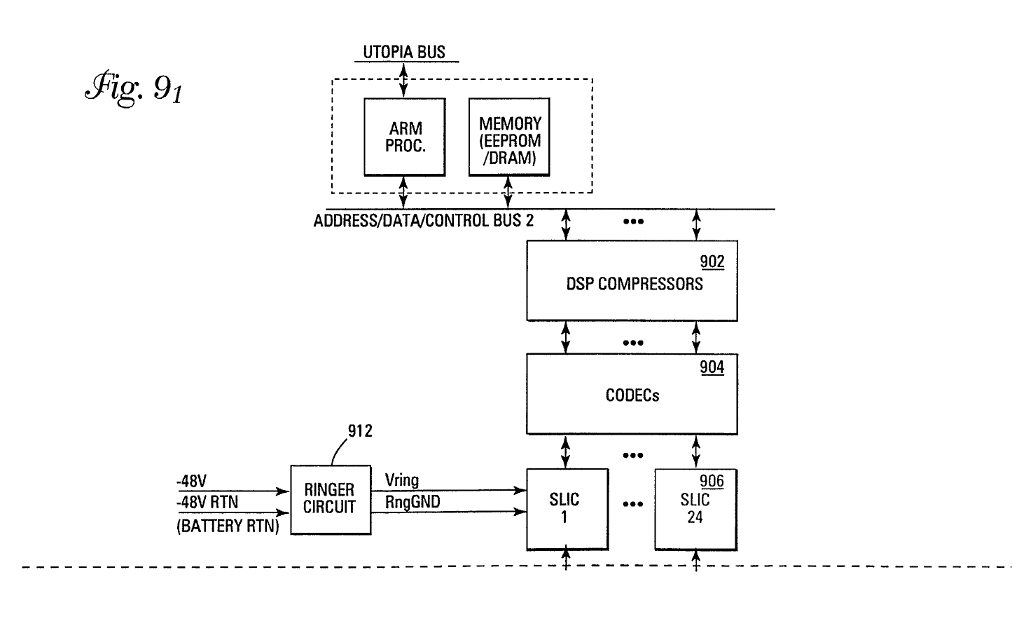

The POTS circuits comprise a gate array (or field programmable gate array) (not, shown), DSP compressors 902, CODECs 904, SLICs 906, POTS filters (low pass micro filters) 908, secondary line protection 910, a ringer circuit 912, and interfaces 910 to the backplane connectors and front panel champ connectors as shown in FIG. 9. Additionally, MLT relay matrix 916 resides between the POTS secondary line protection 910 and POTS filters 908.

The POTS/MLT card provides in this embodiment 24 complete central office side POTS filters for 24 subscriber loops coming in from the front panel champ connector. The loop side of each POTS filter 908 is connected to a respective subscriber loop after the MLT relay switch (not shown). The ADSL side of each POTS filter 908 is connected to the companion 24-port ADSL card via the backplane connector 914 and the cable in the back of the chassis. The POTS side of each filter 908 is connected to the analog voice circuit on-card to provide baseband POTS service over a long subscriber loop.

The on-board voice processing microprocessor typically located in an ARM or voice processor block such as block 114 of FIG. 2 is responsible for controlling the POTS service circuit and communicating with a voice gateway. The on-board management processor provides the voice processor block with the parameters necessary to configure the voice circuits and parameters (VPI/VCI) of connections (PVC) to the voice gateway. The voice processor configures the following parameters for each voice channel: u-law/A-law; ADPCM; compressed PCM; non-compressed PCM (64 Kb); impedance (600 Ω, 900 Ω, complex); loop start/ground start; PVCs; and ringing frequency diagnostics.

MLT Requirements

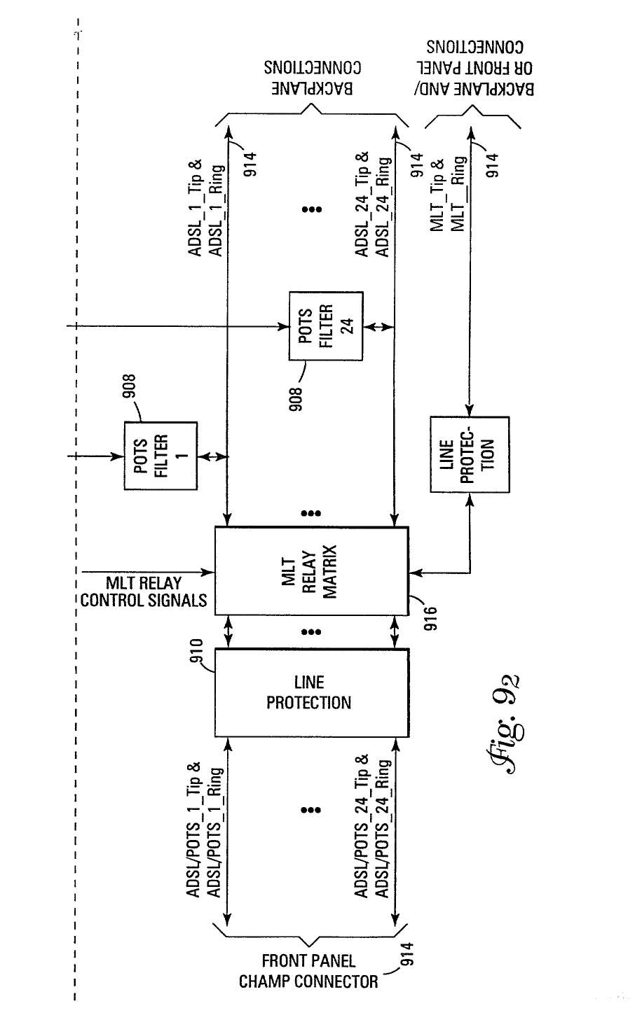

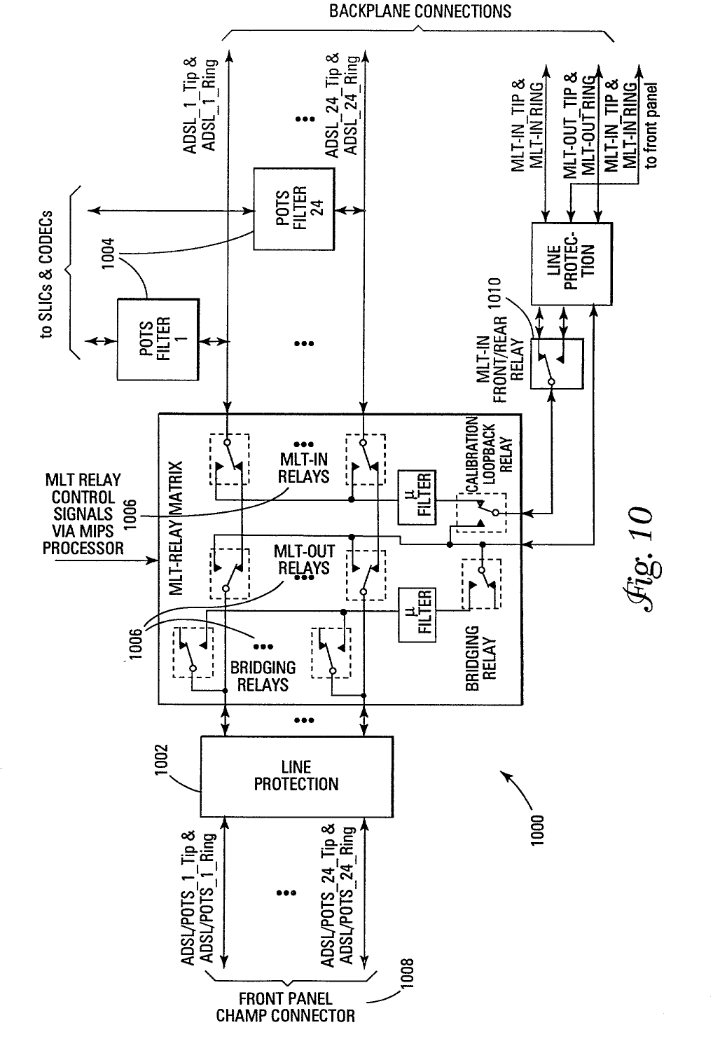

The MLT relay matrix 1000 shown in greater detail in FIG. 10 resides between the POTS secondary line protection 1002 and POTS filters 1004 and comprises a gate array (or field programmable gate array, not shown) to control the matrix 1000, relays 1006, an interface 1008 to a front panel champ connector through the line protection 1002, an interface to a front panel RJ-11 connector, an interface to a backplane connector, and a relay 1010 to switch the MLT-in between the front and rear interfaces.

The POTS/MLT card provides a relay switch for each tip and ring pair of the 24 subscriber copper loops connected to it. In the normal operation, the relay switch connects its subscriber loop to the corresponding ADSL port and POTS filter. This is its default (normally closed) position. Under command of the MLT tester and control of the on-board microprocessor, the relay may switch to an MLT look-out position (MLT-OUT test path to subscriber loop) or an MLT look-in position (MLT-IN test path to POTS filter—ADSL port and POTS port), or bothe simultaneously. At any instant, there is at most one subscriber circuit connected to the MLT test path.

The POTS/MLT card provides a relay matrix control circuit operating under the control of the on-board management processor based on commands from the MLT tester. The on-board MIPS processor executes all commands/messages received from the MLT tester via one of the following processes: 1) via the external management card via the cell bus; 2) via another POTS/MLT card via the cell bus; or 3) via the front panel serial interface. The on-board management processor controls the MLT-in relay to switch the MLT-in signals to either the front panel or backplane interfaces.

The relay matrix is described in greater detail in United States Patent Application entitled CIRCUITS AND METHODS FOR TESTING POTS SERVICE, owned by the assignee of the present application, filed on Feb. 5, 2002, and which is incorporated herein in its entirety by reference.

Software

Two types of executable code images exist on the POTS/MLT card. One is boot PROM code residing in non-volatile memory. The second type is a downloadable application image residing in a flash file-system.

In one embodiment, the boot PROM is responsible for the initialization of the card after a power-up initialization or after a card reset. The boot PROM is responsible for loading the application image from the flash file-system and transferring control to this image after a successful load. Each of the voice processor and the management processor in one embodiment has its own boot PROM. The voice processor is in one embodiment responsible for initializing the DSP processor and the DSP environment.

Processor Modules

The POTS/MLT CARD contains in one embodiment two processing modules, the management processor module and the voice processor module. Except for sharing some common components such as the same Printed-Circuit-Board (PCB), chassis slot, and power supplies, the POTS filter/MLT module and the baseband POTS service module operate independently.

The management processor module communicates with the voice processor module via a dedicated internal serial link to provide configuration parameters and status requests. The voice processor module typically has no need to initiate communication with the management processor module, and only responds to requests from the management processor module.

In one embodiment, in order to minimize the complexity of the boot PROM and therefore minimize the chance for a necessary boot PROM upgrade, the management and voice boot PROMs have no knowledge of, nor any interaction with the other modules. The only exception to this is that the management boot PROM may reset the entire voice-processing module during initialization.

Management Processor Module

The management processor module is responsible for communication with an external management card for purposes including, but not limited to, system inventory, parameter configuration, management and voice connection setup (PVCs), reporting status (statistics, traps, and alarms), and saving the configuration information on the external management card.

The management processor module is also responsible for processing commands from the front panel serial interface. The management processor module may receive MLT commands for controlling the MLT relay matrix or may receive card console commands for production diagnostic purposes via the front panel interface. Software permits the production diagnostic function to only be available when the BURN-IN pin is pulled low and must not permit the production diagnostic function to be available during normal usage of the card (i.e. when the BURN-IN pin is high).

The management processor communicates with the external management card and other POTS/MLT cards through the control cell interface of the cell bus interface. The on-board management processor is responsible for configuring, controlling, and servicing the cell bus interface, including interrupt processing and connection setup.

The MLT tester communicates with the management processor of the POTS/MLT card through either the serial port of the external management card or redundantly through any serial port on any POTS/MLT card installed into the same chassis.

If the external management card's serial port is used, then the MLT test commands are sent to the designated POTS/MLT card through the cell bus interface. If the POTS/MLT card's redundant serial port is used, then the POTS/MLT card first determines whether or not the MLT command is intended for itself or another card. If intended for itself, then the management processor executes the command immediately. If intended for another POTS/MLT card, then the management processor forwards the MLT command to the appropriate card via the cell bus.

The software running on the POTS/MLT card's management processor and on the external management card resolves conflicts between receiving MLT instructions from the external management card's serial port or from the POTS/MLT card's serial port. Once an MLT test has commenced via one of the two MLT command sources (via the external management card's serial port or POTS/MLT card's serial port), commands from the other source are rejected or postponed until the current MLT tests have completed. Software notifies the MLT tester whose command has been rejected or postponed, using the appropriate TL-1 protocols. Software has collision control algorithms such that if an MLT command is simultaneously received from both the external management card's serial port and the POTS/MLT card's serial port then the MLT command received via the external management card has priority.

The management processor is ready to receive and execute MLT test commands any time from either the cell bus (forwarded from the external management card or from another POTS/MLT card) or directly from the MLT tester through its own front panel serial connector. Since the MLT test command can be sent to any card while the command itself may be intended for another card, the management processor that receives the command determines the final destination of the command and either executes the command or forwards it to the appropriate destination card via the cell bus.

In normal operation, the management processor sets all relay switches to connect each subscriber loop to the corresponding ADSL port and POTS filter. Under command of the MLT tester and under the control of the management microprocessor, software may switch the relay to an MLT look-out position (MLT-OUT test path to subscriber loop) or to an MLT look-in position (MLT-IN test path to POTS filter—ADSL port and POTS port), or both MLT look-out and MLT look-in simultaneously. At any instant, the software does not permit more than one loop to be connected to the MLT test paths.

When a TL-1 command is received, the designated POTS/MLT card either responds to the command or sends an acknowledge response to the MLT tester within a predetermined time of receiving the command, in one embodiment within two seconds. If an acknowledge rather than a response is sent to the MLT tester by the POTS/MLT card, then the POTS/MLT card sends the actual response to the MLT tester when the response is ready.

Using the serial data link between the two processors, the management processor provides the voice processor block with the necessary parameters to configure the voice circuits and parameters (VPI/VCI) of connections (PVC) to the voice gateway. Additionally, the management processor queries status from the voice processor such as call statistics, port on-hook/off-hook, and ringing. The communication protocol between the management processor and voice processor is based in one embodiment on a set of CLI-type commands. Voice Processor Module

The voice processor module (such as block 114 of FIG. 2) is responsible for controlling the POTS voice circuit and for communicating with and processing commands from the voice gateway. The voice processor within the voice processor module receives its configuration parameters and/or commands from the on-board management processor through the serial port discussed above. In one embodiment, the communication processing between the management processor and the voice processor function takes no more than 5% of the voice processor's total processing unit capacity.

The voice processor module is able to communicate with and interpret commands from a compatible voice gateway using VoATM.

An ARM processor is part of the voice processor module or block. The ARM processor provides VoATM service using the processed data from the DSP processor.

The ARM processor, like the management processor, has its own boot PROM. In order to minimize boot PROM changes, all main software functionality of the voice circuit is implemented in a downloadable image. The ARM processor's boot PROM loads its application image from a voice processor block flash file-system at boot time. ARM processor application software upgrades are performed through the management processor. The new application image is saved on the voice processor block's flash file-system for use in subsequent boots.

The ARM processor application software is responsible for collecting status of the voice processor block and the voice processing block, including those from the DSP, and passing them to the management processor when requested. The ARM processor reports the POTS port status (off-hook/ringing/on-hook) to the management processor on a predetermined schedule, in one embodiment 10 times a second, via the serial interface between the management processor and the voice processor.

Until the voice processing unit (comprising the voice processor block and the voice processing block) is started by the management processor using a command sent through the serial port, the ARM processor keeps the POTS line interface circuits in a “power-on-reset” state so that they do not interfere with the subscriber loop. During normal operation and once the voice circuits have been operational, the ARM processor maintains the voice circuit operation as long as it can still communicate with the voice gateway, even if the ARM processor itself loses communications with the management processor.

Voice Processing Unit DSP Processors

In one embodiment, two DSP processors are part of the voice processing unit. One function of the DSPs is to manipulate digitized voice data from the POTS line interface unit.

An executable code module for the DSP processors is downloadable. The voice ARM processor is responsible for downloading the code for the voice DSP. The voice DSP communicates with the voice ARM processor for status, statistics, and configuration parameters.

Software Updating

Updating the software for the system includes for example remote software program updating, automatic detection of incompatibility, software program identification, non-service affecting operation, and identification of new hardware. Software upgrade of the application images is done in one embodiment through a resilient boot PROM. The software is capable of downloading new software from the external management card and provides a means of reverting to the previous (before the update) version of the software. The reversion occurs in the event of a corrupted download or through an explicit command from the user. The software is also capable of identifying the hardware revision of the PWB.

The boot software residing in the boot PROM is designed to minimize the probability of change after its initial release. All functionality that is likely to change is implemented in the operational software image.

Power Up and Initialization

The POTS/MLT cards of the various embodiments of the present invention do not require any intervention by a technician to power-up and become operational in the customer-default mode or valid saved configuration modes after completion of self-test and initialization. Upon power-up, the POTS/MLT card performs a self-test as described below.

If the self-test determines that the card needs replacement, then the card does not proceed with operation on any of the ports. If the self-test determines that the card is operational but there are failures on any port, then the card proceeds with normal operation for the operational ports. In this instance, the failed ports are disabled, the fault is reported to the external management card and therefore to the central office or the like, and the fault LED turns on.

When power is lost, the card is reset, or the card is reset by a system reset command, the POTS/MLT card restarts automatically upon power restoration or removal of reset without technician intervention. Upon reset, all three microprocessors (management, voice, and DSP) reset, all microprocessor parameters and registers reset to default states, all CPLD, FPGA, and gate array registers reset to default states, all POTS channels, registers, and circuitry reset to default states, and all other registers on the card reset to default states.

Functional Testability

The POTS/MLT card in one embodiment includes a diagnostic self-test algorithm executable upon an external command from the management system. The self-test verifies proper hardware operation. The self-test tests the board functionality. The self-test generates information for passing to the external management card. In one embodiment, the information is one of the following status indicators:

1. Card is fully functional;

2. Card has a problem that requires card replacement;

3. Certain ports are not functional due to the on-board (and not external) problems. The card and a number of ports are fully functional;

4. Self-test must be automatically invoked every time upon power up or management command.

In the self test, the following tests are performed:

a) The POTS/MLT card tests the audio path by placing all SLICs in loopback mode, generating a 1K Hz test tone from the DSP, passing the test tone from the DSP, to CODECs, to SLICs, looped back to CODECs, and finally back to the DSP. The DSP verifies that the 1K Hz test tone looped back is correct with no more than 2 dB loss.

b) The POTS/MLT card verifies SLIC operation by performing on-hook/off-hook test.

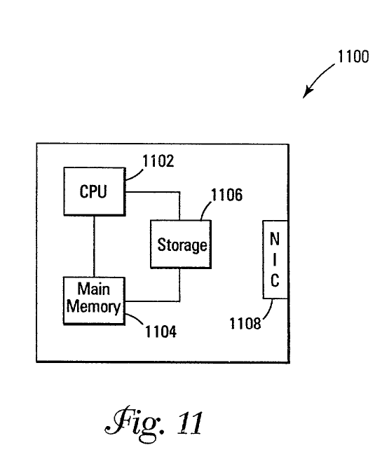

The various methods described herein may be implemented in whole or in part in various embodiments in a machine readable medium comprising machine readable instructions for causing a computer such as is shown in FIG. 11 or the various processing blocks, modules, or units shown in FIGS. 1, 2, 2A, 4, 5, 6, 7, 9, and 10 to perform the methods. The computer programs run on the central processing unit 1102 out of main memory 1104, and may be transferred to main memory from permanent storage 1106 via disk drive or CD-ROM drive when stored on removable media or via a network connection 1108 or modem connection when stored outside of the computer 1100, or via other types of computer or machine readable media from which it can be read and utilized.

Such machine readable media may include software modules and computer programs. The computer programs may comprise multiple modules or objects to perform the methods described herein or the functions of the various apparatuses described herein. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed:

1. An integrated POTS and MLT card, comprising:
voice processing circuitry to generate voice signals from external voice data;
POTS circuitry connected to receive voice signals from the voice processing circuitry and to generate combined POTS and ADSL signals from the voice signals and external ADSL data signals;
metallic loop tester (MLT) circuitry to receive the combined ADSL and POTS signals and to allow MLT testing of the combined ADSL and POTS signals; and
a command module to control the voice processing circuitry, the POTS circuitry, and the MLT circuitry.

2. The card of claim 1, and further comprising:
an ADSL card piggybacked to the POTS and MLT card.

3. The card of claim 2, wherein the ADSL card is piggybacked via jumpered backplane-champ connectors.

4. The card of claim 1, wherein the POTS circuitry further comprises:
a plurality of POTS splitters, a POTS splitter for each of a predetermined number of combined ADSL and POTS channels to be generated by the POTS circuitry.

5. The card of claim 4, wherein the number of channels is 24.

6. The card of claim 1, wherein the voice processing circuitry comprises:
a voice processor block with a voice processor and a memory;
a voice processing block comprising:
a digital signal processor;
a plurality of coder/decoders to encode and decode voice data; and
a plurality of subscriber line interface circuits (SLICs), a SLIC for each of the channels.

7. The card of claim 1, wherein the MLT circuitry comprises:
an MLT relay matrix to select, under control of the command module, a particular line for testing.

8. A telecommunications line card assembly, comprising:
a combined POTS and MLT card; and
an ADSL card piggybacked to the combined POTS and MLT card.

9. The telecommunications line card assembly of claim 8, wherein the ADSL card is piggybacked via jumpered backplane connectors.

10. The telecommunications line card assembly of claim 8, wherein the combined POTS and MLT card comprises:
voice processing circuitry to generate voice signals from external voice data;
POTS circuitry connected to receive voice signals from the voice processing circuitry and to generate combined POTS and ADSL signals from the voice signals and external ADSL data signals;
metallic loop tester (MLT) circuitry to receive the combined ADSL and POTS signals and to allow MLT testing of the combined ADSL and POTS signals; and
a command module to control the voice processing circuitry, the POTS circuitry, and the MLT circuitry.

11. The telecommunications line card assembly of claim 10, wherein the POTS circuitry further comprises:
a plurality of POTS splitters, a POTS splitter for each of a predetermined number of combined ADSL and POTS channels to be generated by the POTS circuitry.

12. The telecommunications line card assembly of claim 10, wherein the number of channels is 24.

13. The telecommunications line card assembly of claim 10, wherein the voice processing circuitry comprises:
a voice processor block with a voice processor and a memory;
a voice processing block comprising:
a digital signal processor;
a plurality of coder/decoders to encode and decode voice data; and
a plurality of subscriber line interface circuits (SLICs), a SLIC for each of the channels.

14. The telecommunications line card assembly of claim 10, wherein the MLT circuitry comprises:
an MLT relay matrix to select, under control of the command module, a particular line for testing.

15. The telecommunications line card assembly of claim 10, and further comprising a backplane asynchronous transfer mode cell bus to which the command module and the voice processing circuitry are connected to receive voice data.

16. A combined POTS and MLT card, comprising:
a voice processing block to generate voice signals from incoming voice data;
a plurality of POTS splitters to combine a plurality of external ADSL signals and the plurality of voice signals;
a metallic loop tester block (MLT) to receive the combined ADSL and POTS signals; and
a management processing module connected to the voice processing block and to the MLT block to control operation thereof.

17. The card of claim 16, wherein the management processing module is connected to the voice processing block via a serial port.

18. The card of claim 16, wherein the management processing block and the voice processing block are connected to a backplane asynchronous transfer mode (ATM) cell bus to receive voice data.

19. The card of claim 16, wherein combined POTS and ADSL signals output from the MLT processing block are subjected to line protection.

20. The card of claim 19, wherein the line protected combined POTS ADSL signals are presented to a subscriber via a connector on a front panel of the card.

21. A method of providing POTS and MLT on a single card, comprising:
providing a management module connected to control a POTS circuit and a voice processing circuit;
receiving external voice data through an ATM bus to the voice processing circuit;
extracting a predetermined number of voice channel signals from the voice data;
receiving external ADSL data to the POTS circuit; and
combining in the POTS circuit the received external ADSL data and the extracted voice channel signals to generate a plurality of combined POTS and ADSL channels.

22. The method of claim 21, and further comprising:
providing metallic loop testing (MLT) circuitry between an output and the POTS circuit; and
testing one of the plurality of combined POTS and ADSL channels with the MLT circuitry upon receipt at the MLT circuitry of an external test signal.

23. The method of claim 21, and further comprising:
piggybacking an ADSL card to the single card via champ connectors.

24. A method of operating an integrated POTS and MLT card, comprising:
receiving external voice data and a plurality of ADSL channels at the card;
decoding a plurality of voice channels in voice processing circuitry;
combining the voice channels with the ADSL channels in POTS circuitry; and
outputting a plurality of combined ADSL and POTS channels from the card.

25. The method of claim 24, and further comprising:
initiating a metallic loop test for a predetermined combined ADSL and POTS channel at the receipt of an external test command.

26. The method of claim 25, wherein initiating a metallic loop test comprises:
selecting the predetermined combined ADSL and POTS channel in a metallic loop tester relay matrix.

27. The method of claim 24, and further comprising:
protecting the outputted signals.
